(19) United States
(12) Patent Application Publication
(10) Pub. No.: US 2002/0165921 A1
(43) Pub. Date: Nov. 7, 2002

(54) Method of multiple computers synchronization and control for guiding spatially dispersed live music/multimedia performances and guiding simultaneous multi-content presentations and system therefor

(76) Inventor: Jerzy Sapieyevski, Washington, DC (US)

Correspondence Address: Steven M. Rabin, RABIN & BERDO, P.C., 1101 14TH Street, N.W. Suite 500, Washington, DC, 20005, US

(21) Appl. No.: 10/128,245

(22) Filed: Apr. 24, 2002

Related U.S. Application Data
(60) Provisional application No. 60/287,782, filed on May 2, 2001.
(60) Provisional application No. 60/295,840, filed on Jun. 6, 2001.

(51) Int. Cl. G06F 15/16

(52) U.S. Cl. 709/204; 709/248; 84/483.1

(57) ABSTRACT

This method and system is primarily implemented for multiple computers-guided performance by an ensemble of musicians utilizing the Internet/Intranet network. Different parts (“sheet music”), accompanying sounds, instructions, etc., of a larger, multi-layer composition are individually controlled and automatically displayed at appropriate times onto the respective monitors of multiple computers. These multiple parts are loaded without user input, individually timed and retrieved for each computer. Different elements of the composition are separately displayed for each of the performers, in such a way that when executed together they create a unified totality of the composition/presentation. This system has a number of possible configurations, such as controlling contemporaneous, multicontent classroom instructions and/or artistic presentations. In particular, an embodiment of this method is used for multiple computers-guided music or multimedia performance where performers do not need a conductor or to be physically proximate to one another.

### CROSS-REFERENCE TO RELATED APPLICATIONS

This application claims priority benefits under 35 U.S.C. § 119(e), and incorporates by reference provisional application Nos. 60/287,782 filed May 2, 2001, and 60/295,840 filed Jun. 6, 2001.

### FIELD OF THE INVENTION

The invention combines existing networking technology, integrating new configurations and apparatus with new techniques of music composition to benefit specifically but not exclusively, new types of creations and events for the performing arts. The invention pertains to the field of use of a computer network in live, simultaneous multi-content presentations. Instead of the computer being used merely as a tool, the computer is an active participant in an ensemble of computers, each playing a separate part in the performance. The result is a symphony of computers with live performers dispersed throughout the venue and/or across many locations. The invention provides a new way of utilizing computer processing and networking technology in live music/multimedia concert automation, and is a specific system tailored to accommodate the intricacies of a new type of music performances.

### BACKGROUND AND SUMMARY OF THE INVENTION

Initially, it is to be noted that throughout this document the several words have specialized definitions understood by those skilled in the fields of music and computers:

“Composition” (usually designed by a composer) means an artistic arrangement of music parts (score) and various other content/elements which when performed or executed together form a unified whole.

“Performance” means execution or presentation of the composition by the performers.

“Part” means a portion or a layer of the composition to be performed by a particular instrument, voice; role or any other element of the composition to be assigned for execution

“Sheet Music” means a graphic representation of music notation to be read and executed by a performer trained in reading music.

“Cue” means the place in composition where, or signaling the time in the composition when, the element or part is to be executed.

“Midi” (Musical Instruments Digital Interface) is commonly used digital language for connecting electronic instruments so they communicate with each other.

“Script” refers to any known Internet programming language such as Java Script or VB Script.

“Session” in some scripting languages, is the time while the browser is opened in an Internet Browser environment.

“Localhost” the root of the URL address when a computer operates as its own server.

“Computer Program” includes: software (i.e. WordPerfect), scripts (i.e. Java Script) and codes (i.e. HTML).

Computer technology enables users in different locations to communicate with each other. The network can be a platform for many shared activities, including music making. In most cases however, music web sites are designed to present music recording for listening or downloading (i.e. MP3) or to display music material for viewing or sale. Existing web sites are not designed to create a combined simultaneous performance outcome or material. This is because most Internet sites so far, merely communicate or display data “on demand”. Music composition and its performance require predetermined synchronization and timing of many single elements. An orchestra can consist of 100 musicians most of whom are playing different instruments and different parts. In an orchestra, the musician must be in close proximity of other players, e.g. on a stage, and if the ensemble is large, a conductor is needed to lead all the players, among others, to achieve certain precision in the timing of the execution.

The principal benefit of a computers-guided performance is to create a totally new way of performing and listening to music. This system also enables performances in a variety of non-traditional venues. In a traditional concert hall, the ensemble is confined to the stage and the listeners are constrained in rows of seats. Such a “static” experience begs the addition of alternative ways of listening to music that transforms the relationship between the performers and the public. A particular use of the method, named by the inventor “webOrchestra”, offers an embodiment for multiple computers-guided music/multimedia performance where performers do not need to be physically close to each other on stage nor do they require a conductor.

Until now, performances of this type would only be possible if a conductor, utilizing a closed circuit TV, led the performance. The “webOrchestra” method is inexpensive and practical. It provides an unlimited number of possible configurations creating an opportunity for substantial community (audience) participation. Even those who do not play an instrument will be able to trigger sounds, pre-composed musical phrases and other elements of the composition from their respective computers and thus participate in the interactive composition.

The invention utilizes well-known server technology to guide a musical ensemble performance. The invention automates and times the display of the parts of the composition so no “page turning” or other action by the performer is needed in order to play the music on traditional instruments (e.g. trumpet, violin etc.). In addition, other multimedia elements can be scheduled to accompany the performance. In cases when the musicians are dispersed throughout large spaces, the composer should accommodate for the architecture of the venue, acoustics and other site-specific aspects. In some cases, an amplification system has to be used and separately designed for the performance to be effective.

The invention is described below with terminology understood by persons knowledgeable of the practices of those skilled in the art of music and music notation reading, with reference to acts and operations that are performed by the system in the course of a musical event (concert) or equivalent of such an environment. The apparatus includes individual computers connected to a network with a browser e.g. Internet Explorer™, and a server storing the content files with the parts and other elements of the composition as well as performers' passwords and various computer programs (i.e. scripts) controlling the server's output. A plurality of computers coupled to the network, also have a display monitor, at least one input device and at least one output device, audio and MIDI (Musical Instrument Digital Interface) output and a version of Microsoft™ PWS (Personal Web Server) or IIS (Internet Information Server) or similar computer program.

In order to implement these mechanisms, the invention utilizes a JavaScript and/or VBScript for Active Server Pages (ASP), web browser and the Windows Media Player (for accompanying audio/midi). Use of other programming languages and computer systems is possible. Each of these items is well known in the art and does not require further explanation.

Using well-known techniques, an HTML page is created. All of the elements/parts of the composition to be stored on the server can be created using any number of well-known tools. For example, Adobe Photoshop, Paint, music notation/audio/ midi recording programs such as Finale, Cubase, etc., can be used to create content using GIF (graphic interchange format) image files, WAV or other audio formats. Once the scripts for timing of the distribution of the elements have been created, specific individual pages to be displayed should also be created. All pages should be placed on the web server in separate files that the associated user will access. Specific techniques for completing these steps are well known and need not be specifically described.

The principal embodiment of the invention is adapted for use with performers stationed a small distance from each, not necessarily within each other's view, but able to hear one another. In another embodiment, if the distances necessitate, microphones/amplifications can be employed. Displays of different musical parts, (“electronic sheet music” and instructions) are synchronized and timed by scripts running from the server and simultaneously exhibited to the respective performers, on monitors of multiple computers. Each performer or small group of performers is assigned a computer terminal to view and be guided by the appropriate pages of musical composition (notes) and instructions (such as a metronome count of tempo or text instructions for musical interpretation). This system also allows showing the music notes in color, and thus two or more versions of the music can be played from one screen. For example, one player plays only red notes, the other only black notes etc.

The invention utilizes a network, such as the Internet or an Intranet to execute the scripts and automatically display the appropriate musical part to be played. The program uses a database containing passwords for each authorized user. Performers receive a password via email or other means. Each password is specific for the person and/or the part to be played.

The query refers the performer to the appropriate part or other content assigned to that password.

Depending on the size of a venue, computer terminals (connected to the Internet or a local network) are distributed throughout the building taking into consideration acoustical aspects, architecture and movement of the audience. A performer (or a small group) is placed in front of each of the terminals. After connecting to the site's URL, and the entry page the performer will enter a password, which is pre-assigned by the content provider (composer). This information should match the assigned part of the composition, as well as any additional information that will link the musician to the appropriate URL/site where his/her part is stored with instructions and timing script.

After reading the instructions the performer clicks to begin playing and waits for the “sheet music” to appear on the monitor. Each computer terminal displays only the part that is assigned to it. From this point on the elements of the performance are coordinated between the terminals and automatically displayed at appropriate times, without any user input. The script (after checking the time) then displays the first page of the music to be played by the assigned instrument. The page is timed until the next cue and the second page is displayed and so on until the whole composition is sequentially transmitted. This routine is the same for each performer, yet the content they receive is different and specifically timed so when heard/executed or seen together it creates the totality of the composition. In addition, the part can include a lead-in visual or audio metronome or other real time instruction. As the musician continues to play, other elements could be timed and activated during the sequence. For instance, a timed MIDI signal could send information to an outboard device such as an electronic keyboard, lighting system etc. An accompanying audio could be streamed from the server or come from a radio/TV broadcast. The output then might be sent to the venue's PA system, depending on the size and the acoustics of the location. Because each computer's internal clock can be set differently, the timing is controlled by server-side scripts (e.g. JavaScript, VBScript) or similar computer program. The scripts check the time and send out the appropriate commands. This is to secure timing of varied contents on multiple computers. The scripts select the appropriate pages of music and distribute the parts including tempo and other instructions, at the proper time to the respective terminals to be played together. If a script checks the time and it is not appropriate for the next cue, it will automatically wait for the next cue to retrieve the appropriate content. The inventor has used VisualBasic Script to create Active Server Pages (ASP) to control timing, content and coordinate the display or execution of the elements of the composition, as designed by the composer. However, those of skill in the art of computer network programming could use other programming language (software) to carry out the invention.

The type of network used is immaterial, except that it should be fast in response (i.e. DSL, or cable). In addition to the network (Internet/Intranet), other suitable method for executing this invention could use Microsoft™ PWS (Personal Web Server) or IIS (Internet Information Service) individually for each computer to operate as its own server. This approach is recommended only if the Internet connection is slow or unreliable. In such case, each computer's internal clock has to be set to a Remote Time Server e.g. swisstime.ethz.ch, tick.usno.navy.mil or another public Remote Time Server—a service which provides a constantly updated time of day reading (in hours, minutes, and seconds) and means of setting individual computer's clocks. Then all respective files with the elements of the composition and appropriate scripts should be downloaded to the individual computers. After this, the computers may be disconnected from the network and moved to a desired location for the duration of a performance.

Although the following is not intended as the principal embodiment of this technique, this method also can be used to replace “sheet music” stands and page-turning for traditional orchestras. In such case, instead of printed sheet music, each musician, including the conductor, would have his/her individual computer screen instead of a traditional music stand.

The program, process and the method described here can work on variety of types of computers and servers and the process can be creatively augmented on the principle presented by the inventor. The principle of this method can have numerous embodiments, which may be created within the scope and spirit of the method by persons skilled in the fields of the invention.

### BRIEF DESCRIPTION OF THE DRAWINGS

The invention will now be described with reference to the preferred embodiment illustrated in the appended drawings, in which:

FIG. 1 is a chart illustrating the overall system and the interrelationship of the various hardware components with multiple terminals displaying a plurality of elements to be performed together.

FIG. 2 is a diagram showing system architecture for display of the “sheet music” and optional inclusion of an accompanying element on a single performer computer terminal.

FIG. 3 is a flow chart illustrating sign on routine.

FIG. 4 is an alternative embodiment of the invention displayed on individual computers without a need for constant connection to the network by using Personal Web Server individually on each computer.

FIG. 5 Diagram of the content of the composition to be created in the formats suitable for each of the specified parts and the design of the composition.

FIG. 6 is an illustration of time sequence design for two instruments.

FIG. 7 is a browser environment on a client computer displaying a sheet music page with animated images and colors providing additional instructions and leading the performer.

### DETAILED DESCRIPTION OF THE PREFERRED EMBODIMENT

The invention will be understood from the specification and drawings by those skilled in the art of music and computers. In some instances, well known methods and procedures have not been illustrated in detail so as not to obscure aspects of the invention described in detail in the body of this document.

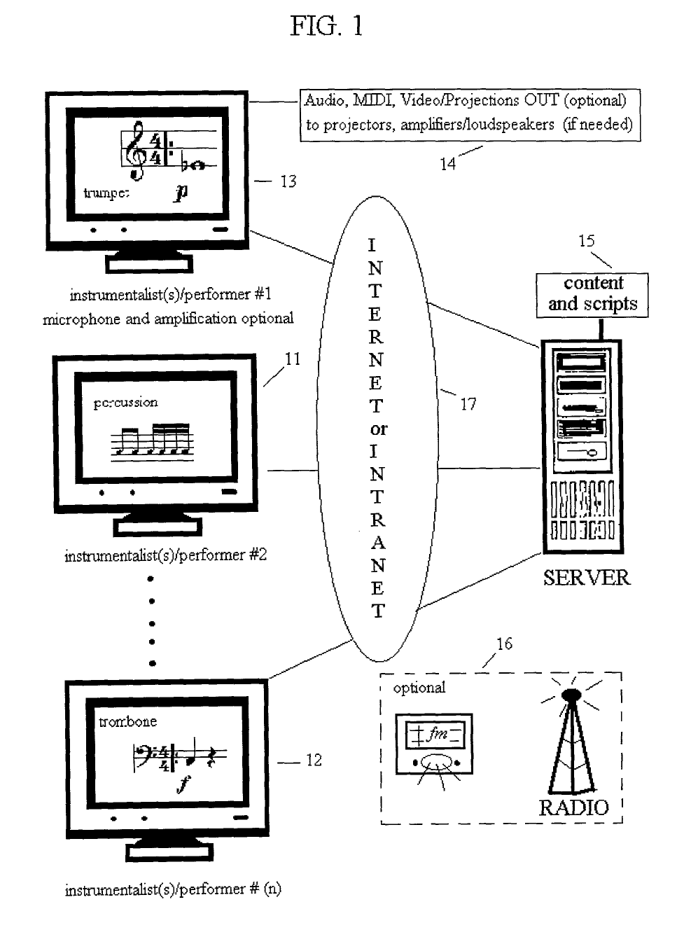

FIG. 1 is a chart illustrating the overall system of the invention, including connections between hardware components and multiple terminals displaying a plurality of elements to be performed together in order to create the totality of the composition. The various elements of the composition are separately and individually timed and displayed on or executed by the computers of the performers 11, 12, 13, in such a way that when played (if an instrument) or executed, (if a non-instrumental part of the performance such as lighting or MIDI controlled electronic instrument/sound) together they create a unified totality of the composition. Optional outputs 14 can be used for additional elements of the composition, such as Midi commands, streaming audio, audio files and visual projections; separately and individually executed from each computer, amplified and distributed throughout the venue. A server 15 stores all content including Scripts to run each part via Internet or Intranet 17. An optional addition can be a prearranged radio/TV broadcast 16 so additional sounds and/or images could be used simultaneously and timed into the multimedia performance.

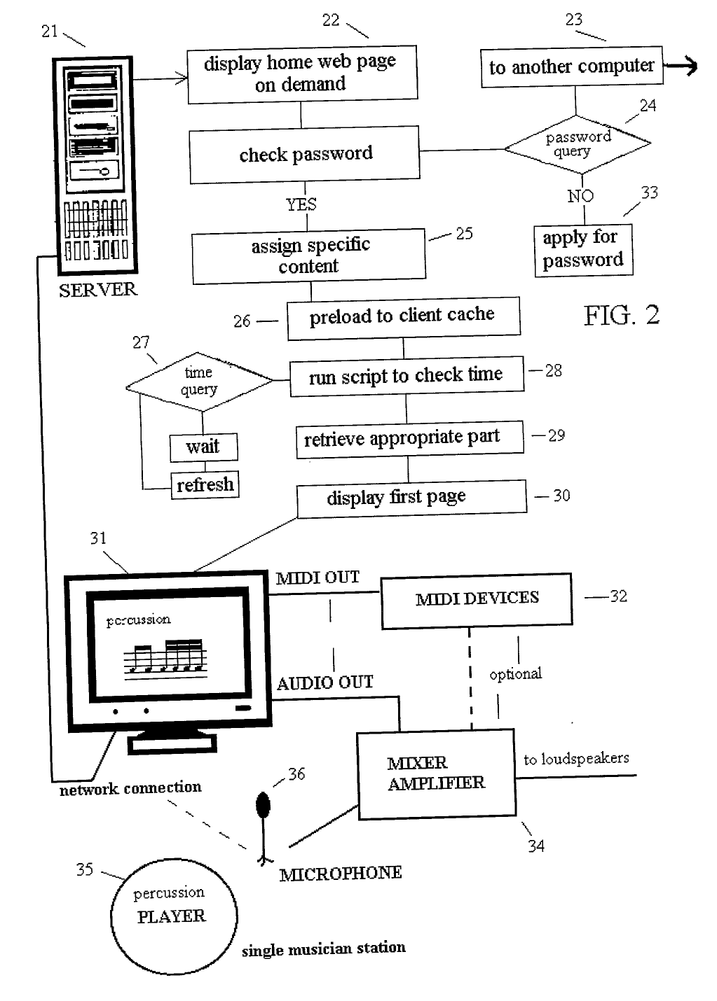

FIG. 2 is a diagram showing system architecture for display of the “sheet music” on a single client computer terminal 31 for use for the performance of one performer 35. The computer terminal 31 is among a plurality of computers, each with a network connection to a server 21 and requiring different content interrelated to the total design of the composition. The diagram also illustrates the integration of multiple elements for one of the computer terminals that participate in the performance.

a. on demand, the server displays “webOrchestra” home page 22 linking to various pages that include:

Log on page for the performers who already obtained their password 24

Application with instructions how to obtain a password 33

b. If the performer enters a correct password, the server displays the initial page of the part assigned to this particular terminal 25. The page includes instructions for the performer and the server automatically pre-loads the assigned elements of the composition into the terminal's cache 26. This technique is widely used to subsequently speed up the display of the elements on the computer when they are later recalled in the actual performance.

c. If ready to begin, the performer clicks START and the server responds by linking to the page that runs the assigned script controlling the timing 27, 28 of the sheet music display and execution of other elements. From here on the performance parts are automatically timed, displayed 30 and executed 32, 34 by the server onto the respective terminal 31, without any user input. In the sequential display of the sheet music and execution of other elements the server, using a script or other programming language, constantly verifies the timing of the display of the elements to match the pre-designed timing of the composition as planed by the composer. To better coordinate the performance each page might include additional instructions i.e. a visual metronome indicating for a particular page. In addition, if the performer is late or stops playing the page will disappear changing to the next page in sequence, at the predetermined time required by the design of the composition and programmed into the respective scripts by the composer.

The routine is the same for each terminal; however, the content and timing are individually customized for each musician to perform the respective part in relation to the plurality of performers participating in the performance of the whole composition. As is familiar to those skilled in the art, the server 21 and the computer system 31 include an operating system and an Internet browser. The browser is a standard browser for displaying content, including hyperlinks. A user can customize the browser to maximize the viewing area, memory allocation etc. In operation, the following steps are preformed: after opening the “home” page at 22, the player links to the password page at 24. Depending on the preassigned password entered, the content will be associated with this terminal at 25 or reserved for another computer at 23. For faster loading during the performance, the content will be pre-loaded into the computers' cache at 26. After the performers click START at their respective terminals, all individual elements (pages and files) of the composition are automatically displayed at 30, one after another in a sequential order in time at 27, predetermined by the composer/content provider at 28. When a current music page is displayed, one or more files such as audio/midi, image projections, etc. 32, relating to that music page can be included and sequentially executed by sending the output from the terminal to a midi device, projector or, in case of an accompanying electronic audio signal, directly to the loudspeakers through the amplification 34. The music page then automatically switches to the next page, which can also include other accompanying media and so on. Different contents are individually customized for each performer, retrieved at 29 and individually displayed at 30 on each computer terminal 31 at the appropriate time 27. Without any user input, automatically and independently for each computer, the next page is retrieved from the server; and at an appropriate time automatically displayed for a single performer. Simultaneously, another part is retrieved for another performer thus displaying multiple parts on multiple computers, which when executed, will result in the totality of the composition. If the venue or distances are large, a microphone 36 can be used to send the sound of the performer to the PA system or to the network to be heard on other computer(s) if they are located at a great distance.

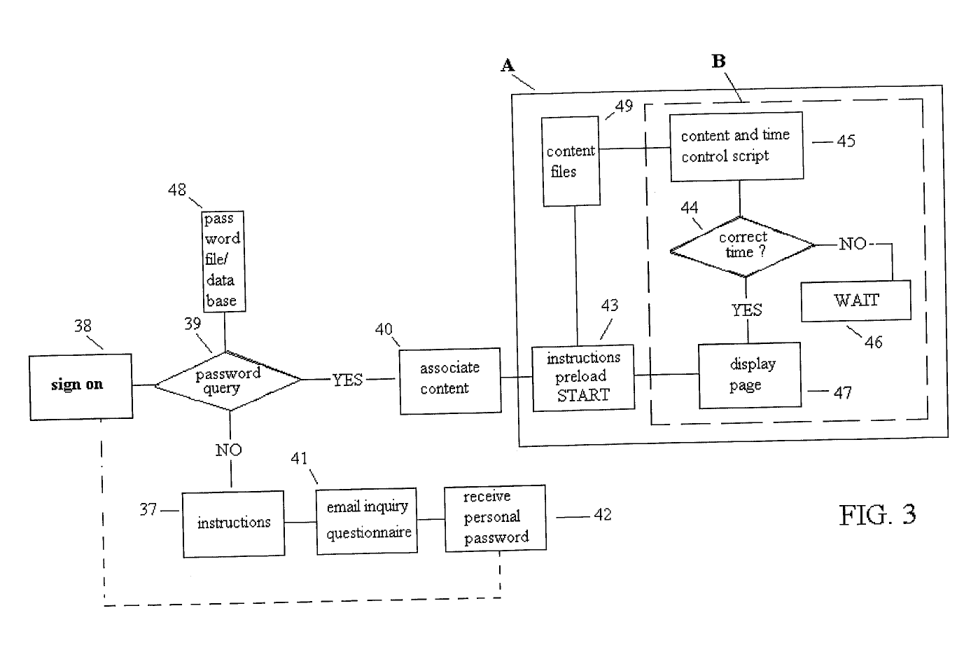

FIG. 3 is a flow chart illustrating a sign-on routine. It includes the timing bypass subroutine 44 and password bypass subroutine 39.

After signing in at 38, any entry through a valid password at 39 is stored as a “session” so if the performer should stop playing for a period of time, the performer can quickly join the performance at any time without reentering the password.

If a wrong password is entered a page is linked to instructions 37 on how to receive a valid password. Performers can receive individual passwords via email at 41, 42 or by other means. The password is specific for the person and/or for the element of the composition to be executed and is associated with the corresponding files containing the assigned elements for the terminal from which the password was received 40. The assigned passwords are stored in a server file/database 48 and verified by the server subroutine 39.

Once the password is accepted, the server automatically associates the appropriate parts and other elements of the composition for display on the terminal from which the password was received. The server retrieves the files from its storage 49 and pre-loads them at 43. After reading the instructions about the performance, the performer clicks START and from here on the assigned parts are automatically displayed or executed (subroutine A) with no need for any user input.

The content pages are displayed and other elements are executed automatically and sequentially one after another at the appropriate, predetermined, time-controlled at 44, 45 by the script. If the time for the display is not right, as predetermined by the composer, the script will wait at 46 before displaying the part at 47. (subroutine B)

The process is the same for each performer yet resulting in simultaneous, time-controlled display of different parts and elements of the composition, individually and independently on the respective terminals associated to the respective parts by individual passwords.

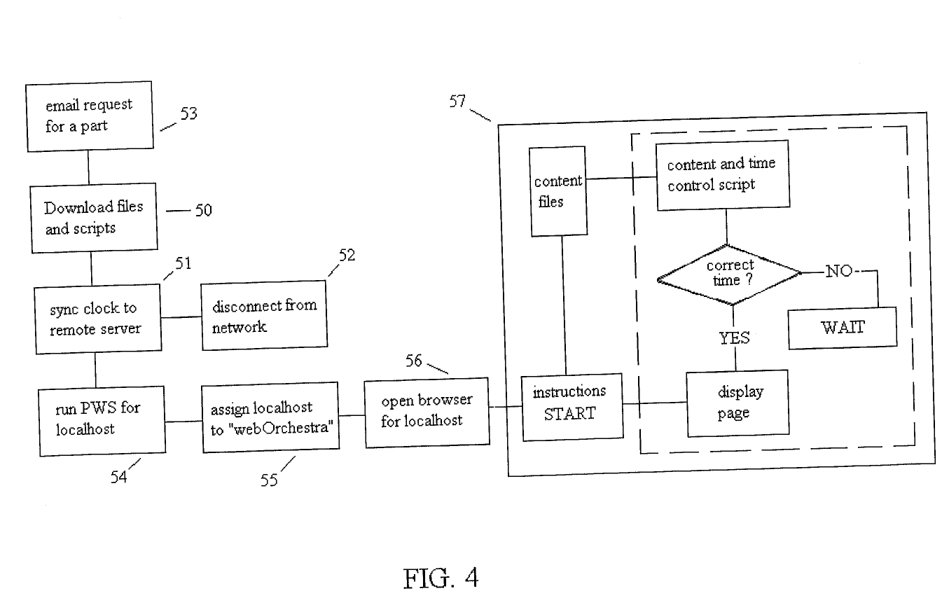

FIG. 4 is an alternative embodiment of the invention displayed on individual computers without a need for constant connection to the network by installing Microsoft™ Personal Web Server™ or similar program, individually on each computer. The invention may be alternatively or simultaneously embodied for displaying from public or private computer networks. The choice of preferred network depends on speed and reliability. The extreme of this embodiment would be the exclusive use of PWS (Personal Web Server) or equivalent program running each computer separately.

1. All respective files with the parts of the composition and appropriate scripts must be downloaded to the individual computers by e-mail request 53 and a download 50. Alternatively, the content could be provided on a CD-ROM. The download might also include instructions how to install and run Microsoft™ Personal Web Server™ or equivalent program that makes the computer operate as its own server.

2. Each computer's internal clock has to be set to a Remote Time Server 51, e.g. swisstime.ethz.ch, tick.usno.navy.mil or another public Remote Time Server—an Internet service which provides a constantly updated time (in hours, minutes, and seconds). After this, the computers may be disconnected from the network 52 and moved to a desired location for the duration of the performance. By installing and running Microsoft™ Personal Web Server™ or equivalent system at 54, 55 each computer terminal becomes its own server.

3. Each performer logs on to “localhost” by opening the browser to the same URL address as if connected to the Internet 56, except that the root of the address is changed to “localhost”. For example, http://localhost/weborchestra/weborch.htm instead of normal http://www.weborchestra.com/weborchestra/weborch.htm. This procedure displays the first page of the previously downloaded content, now stored on the local hard drive. The performer then proceeds the same way as described herein when using the Internet/Intranet network.

The process of the performance and the final result stay the same as if using the Internet network. It allows performers distant from each other to be guided by the computers to produce the totality of the composition. The routine 57 of automatically displaying the parts becomes the same as in FIG.3. This method of utilizing Microsoft™ Personal Web Server™ or equivalent computer program basically enables the performance without constant dependence on the network connection.

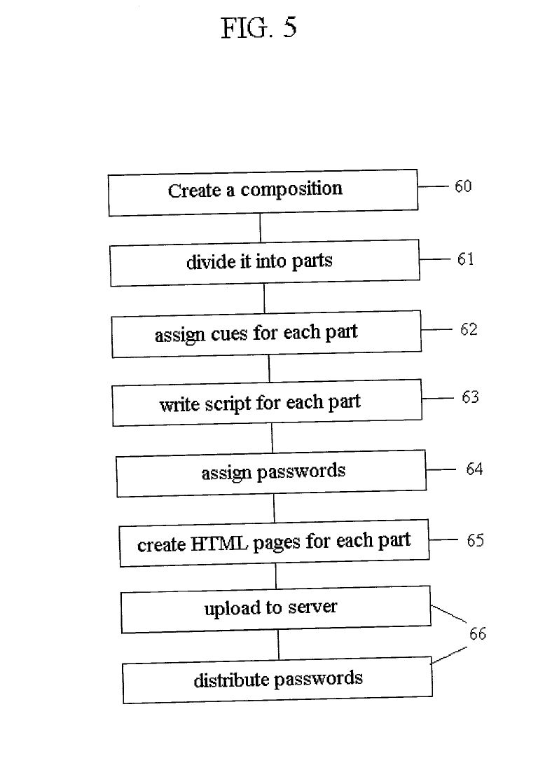

FIG. 5 is a diagram of the content of the composition to be created in the formats suitable for each of the specified instruments and the design of the composition. In order to implement the invention, the following steps are employed to provide content:

a. Create a composition in a format suitable for this technique 60 and for display within a web page that loads different “sheet music” images or other multimedia formats, at certain times predetermined by the composer;

b. Divide the material into files specifically associated with a particular performer or group of performers and assign separate passwords 61;

c. Assign specific timing/cues for each part 62;

d. Add timed instructions, scripts with timing and display commands 63;

e. Assign individual passwords to the respective parts 64;

f. Create an HTML (or equivalent) layout 65;

g. Upload to a server and distribute passwords 66;

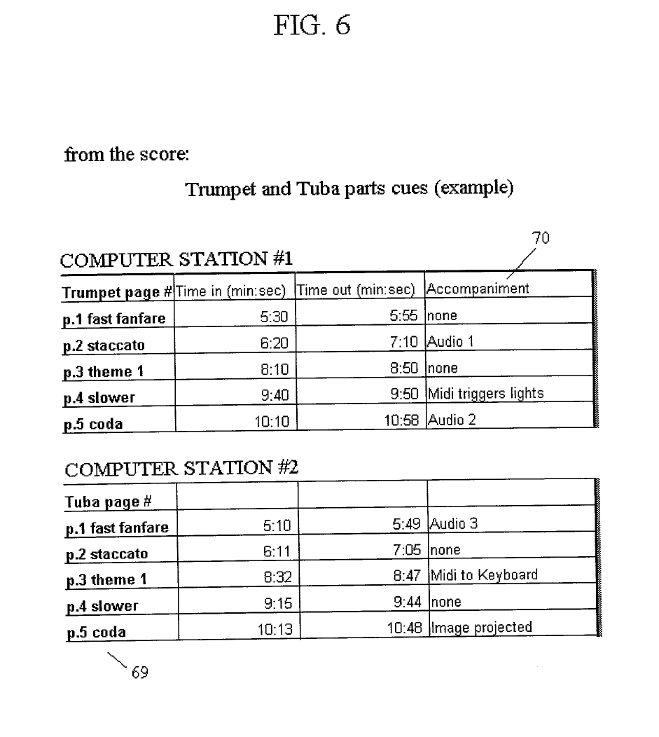

FIG. 6 is an illustration of time sequence design for two instruments using multiple contents 69 from one server to display individually on each of the musicians' computers including additional, optional elements 70.

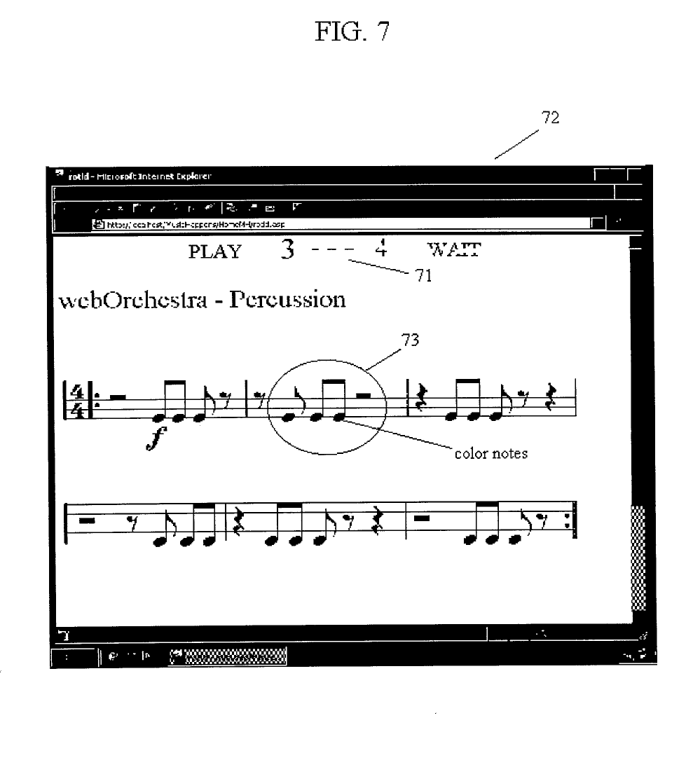

FIG. 7 is a known browser environment 72 on a client computer. It represents a portion of the “sheet music” display in a browser environment with color notes 73, which are referred to in instructions at the beginning of the performance. For instance, the instructions could direct the musician not to play red color notes or to wait until the musician hears the color marked notes etc. The use of color representation of “sheet music” in this invention enables the parts to be displayed on one of the monitors as several versions with “hidden” cues, instructions, and variations. Also, red/color numbers serving a visual metronome to show the required tempo for a page or other timed animation 71 such as words “PLAY”, “WAIT”, could be included to lead the musician playing this part.

Having described and illustrated the principles of the invention, it will be recognized that the embodiment can be modified without departing from the basic principles of the invention. This method opens new ways of utilizing computer networks for creating multi-contents events and specifically the music/multimedia performances that could not have existed before.

What is claimed is:

1. A computer network for guiding a performance of a musical composition by an ensemble of musicians, comprising:
a server;
a plurality of computer terminals;
network means providing Intranet or Internet connection of the server to each of the terminals;
the server having:
means for storing a musical composition, the composition being divided into a plurality of elements, the elements including separate sheet music to be performed contemporaneously at the respective terminals, the musical parts corresponding to the respective terminals,
means for transmitting the separate sheet music to the respective terminals for display thereon, and
means for independently and automatically controlling, contemporaneous display of the separate sheet music on the respective terminals, timed throughout the performance so that the display of the separate sheet music is coordinated in time among the musicians.

2. A computer network according to claim 1, wherein the separate sheet music are stored in respective individual content files on the server, further comprising
means at each terminal, responsive to an input of a password corresponding to a particular separate sheet music, for activating the transmitting means and the display and timing means to transmit the particular sheet music from the respective individual content file, under independent and automatic control throughout the performance, to provide coordinated timing of display of the respective sheet music, without input from the respective terminal.

3. The computer network according to claim 1, wherein said network means includes either an Internet system or an Intranet system.

4. The computer network according to claim 3, wherein the means for independently and automatically controlling:
includes computer programs corresponding to the respective sheet music,
independently creates cues corresponding to the respective sheet music, for use by musicians in the performance, and
transmits the cues to the terminals.

5. A computer network for guiding a live performance of an artistic composition divided among a plurality of elements, comprising:
a server;
a plurality of computer terminals; and
network means connecting the server to each of the terminals;
the server having:
means for storing the composition to be contemporaneously executed at the respective terminals, the elements of the composition corresponding to the respective terminals,
means for transmitting the elements to the respective terminals corresponding thereto, for presentation thereon, and
means for independently and automatically controlling presentation of the elements at the terminals throughout the performance so that the presentation is coordinated among the elements.

6. A computer network according to claim 5, wherein the elements are stored in respective individual content files on the server, the server further comprising means, responsive to receipt from any one of the terminals of a password corresponding to a particular one of the elements, for activating the transmitting means and the controlling means to transmit from the respective individual content file throughout the performance the particular element to which the password correspond, via the network means to the terminal from which the password is received, thereby to provide controlled timing of presentation of the respective elements at the terminal, coordinated among the different elements, without input from the respective terminals.

7. The computer network according to claim 5, wherein said network means includes either an Internet system or an Intranet system.

8. The computer network according to claim 7, wherein the server further has
means for running computer programs corresponding to the respective elements,
means for independently controlling with the computer programs, cues corresponding to the respective elements, for use by the performers of the composition, the performers stationed at the terminals to which the respective elements are transmitted, and
means for transmitting the cues to the terminals.

9. A method of guiding a live performance of an artistic composition divided among a plurality of elements, comprising the steps of:
storing the composition in a server, the elements to be performed at respective computer terminals corresponding thereto;
transmitting the elements via a computer network to the respective terminals corresponding thereto, for presentation thereon; and
independently and automatically timing presentation of the elements at the terminals throughout the performance so that presentation is coordinated among the respective elements and terminals.

10. The method of claim 9, wherein the network is either the Internet or an Intranet.

11. The method of claim 10, further comprising the steps of with the server
from the server, running computer programs corresponding to the respective elements,
from the server, independently controlling with the computer programs (i.e. scripts), cues corresponding to the respective elements, for use by the performers of the composition, the performers stationed at the terminals to which the respective elements are transmitted, and
from the server, transmitting the cues to the terminals.

12. A method of guiding according to claim 9, wherein the step of storing includes storing the elements in respective individual content files on the server, further comprising the steps of:
transmitting from any of the terminals to the server a password corresponding to a particular one of the elements; and
from the server via the network in response to the transmitted password, independently and automatically transmitting the particular one of the elements throughout the performance from the respective individual content file to the terminal from which the password was transmitted, thereby to provide timing of presentation of the respective elements, coordinated among the respective elements, without manual input from the respective terminals.

13. A method of guiding a performance of a multi-part music or multimedia composition by an ensemble of performers using an Internet or Intranet computer network connecting a server to multiple computers terminals, each performer accessing the composition stored on the server from one of the computer terminals via the computer network, the composition being divided into plural elements, the elements of the composition including musical parts to be contemporaneously performed by musicians among the performers and other elements that are not musical parts to be contemporaneously performed, the method comprising the steps of
a. transmitting to the server, via the network from each terminal, a password corresponding to an element to be performed at the terminal;
b. for each element including a musical part to be performed by one of the musician, the one musician to access the composition at one of the terminals, providing from the server to the terminal for display on a monitor thereof in response to the password, music cues and time-controlled electronic sheet-music corresponding to the part to be played by the one musician at the terminal, wherein the sheet music is sequentially received as pages at the terminal at predetermined times and for a predetermined duration, to be played by the one musician as a portion of the multi-part music or multimedia composition, the step of providing the music cues and sheet music including timing the music cues and the duration of the pages display, independently for each musician, to match a time-line of the composition, and
c. for each of the other elements, providing to the terminal in response to the password time-controlled transmission of the other element, including other cues, such that the other element is sequentially received at the terminal at predetermined times and for a predetermined duration, wherein each other element excludes sheet music and includes a plurality of contemporaneous, sequential segments, each of the sequential segments of the other element to be performed as another portion of the multi-part music or multimedia composition,
the step c including controlling the timing of the cues and the duration of performance of the segments of the element received by the terminal, simultaneously and independently for each terminal, to match the time-line of the composition.

14. The method of claim 13, wherein the composition further includes a broadcast element as a leading or accompanying part of the composition, further comprising the steps of
in collaboration with an existing radio/TV station, broadcasting the broadcast element fixed in time and independently of the server timing, and
coordinating displays on the terminals with the broadcast element throughout performance of the composition, the server controlling the music cues and other cues to match the timing of the broadcast element.

15. The method of claim 13, further comprising the step of using color-coded music notation for cues and special instructions.

16. The method of claim 13, further comprising the step of transmits cues and further instructions, in the form of color-coded music notation to the terminal for display on the monitor.

17. The method of claim 13, further including the step of using color-coded music notation to exhibit various versions of the same musical part on single monitor.

18. The method of claim 13, including transmitting from storage on the server, to the terminal for display or emission thereon, a visual or audio metronome in the form of at least one of moving images, animated images, words, numbers and sounds.

19. A computer network for guiding a live performance of an artistic composition divided among a plurality of first elements and a plurality of second elements, comprising:
a server;
a plurality of first computer terminals and a plurality of second computer terminals;
network means connecting the server to each of at least the first terminals,
the server having:
means, for storing the plurality of first elements of the composition, the first elements to be performed at the respective first terminals, the first elements corresponding to the respective first terminals,
means for transmitting the first elements to the respective first terminals corresponding thereto, for presentation thereon; and
means for independently and automatically controlling timed, contemporaneous presentation of the first elements at the terminals throughout the performance of the composition so that presentation is coordinated among the different first elements,
wherein each of the second computer terminals corresponds to a respective one of the second elements of the composition, each second computer terminal having
means, for storing a respective one of the second elements of the composition, the stored second element to be performed at the second terminal, and
a computer program including means for operating the terminal as a server only for the terminal and means for setting an internal clock of the terminal to a remote clock and automatically controlling presentation of the second element at the second terminal throughout the performance so that presentation is coordinated among the different second elements.

20. A computer network according to claim 19, wherein the first elements are stored in respective individual content files on the server, further comprising means at each first terminal, responsive to an input of a password corresponding to a particular one of the first elements, for activating the transmitting means and the display and timing means to transmit signals corresponding to the particular first element to the first terminal from the respective individual content file on the server via the network means, under independent and automatic control, throughout the performance, to provide timing of contemporaneous presentation of the respective first elements, coordinated among the different first elements, without input from the respective terminals.

21. A computer network for guiding a live performance of an artistic composition divided among a plurality of elements and a plurality of elements, comprising:
network means;
a server;
a plurality of computer terminals connected to the server by the network means, each having means for transmitting via the network means passwords respectively corresponding to the server,
the server having:
means, for storing the plurality of elements of the composition, the elements to be performed contemporaneously at the respective terminals, and
means, responsive to the passwords, for transmitting the corresponding element to the respective terminals from which the passwords are transmitted, for presentation thereon, and
each of the terminals having
means, storing the element transmitted thereto from the server, and
a computer program including means for operating the terminal as a server only for the terminal and means for setting the internal clock of the terminal to a remote clock and operable after disconnection of the terminal from the network
means, for automatically controlling presentation of the stored elements by the stored computer programs, so that presentation is coordinated among the different elements stored in different terminals.

22. A plurality of computer terminals for guiding a live performance of an artistic composition divided among a plurality of elements, comprising:
network means;
a plurality of computer terminals each corresponding to a different one of the plurality of elements; and
means, for storing the plurality of elements of the composition on corresponding terminals, the elements to be performed contemporaneously at the respective terminals,
each of the terminals having
means, for storing the element of the composition corresponding thereto, and
a computer program including means for operating the terminal as a server only for the terminal and means for setting the internal clock of the terminal to a remote clock and operable after disconnection of the terminal from the network means, for automatically controlling presentation of the stored elements by the stored computer programs, so that presentation is coordinated among the different elements stored in different terminals.
